(19) United States
(12) Patent Application Publication
(10) Pub. No.: US 2012/0214081 A1
(43) Pub. Date: Aug. 23, 2012

(54) Laminate for Use in a Fuel Cell and Method for Making the Same

(75) Inventors: Chien-Kuo Liu, Miaoli City (TW); Kin-Fu Lin, Taipei City (TW); Kun-Chao Tsai, Chiayi City (TW)

(73) Assignee: ATOMIC ENERGY COUNCIL-INSTITUTE OF NUCLEAR ENERGY RESEARCH, Taoyuan County (TW)

(21) Appl. No.: 13/031,299

(22) Filed: Feb. 21, 2011

(51) Int. Cl. H01M 8/10; H01M 8/04; B28B 7/00

(52) U.S. Cl. 429/479; 425/470; 429/512

(57) ABSTRACT

Disclosed is a laminate for use in a fuel cell. The laminate includes at least two field plates and a bonding layer. Each of the flow field plates includes a plate and channels defined therein. The bonding layer is made in the form of an annular strip and sandwiched between the flow field plates, around the channels.

### BACKGROUND OF INVENTION

1. Field of Invention

The present invention relates to a laminate for use in a fuel cell and, more particularly, to a laminate that is made by synchronous heating and pressing.

2. Related Prior Art

A conventional fuel cell includes at least an anode collector plate, a cathode collector plate, a film electrode assembly and flow field plates. These elements are in the form of a plate. These elements are pressed to become a laminate. Conventionally, glass, ceramic or a mixture of glass with ceramic is used to bond these elements at high temperature. Initially, glass powder, ceramic powder or a mixture of glass powder with ceramic powder is provided. Then, paste is made of the glass and/or ceramic powder. The paste is provided between any two adjacent ones of these elements such as two flow field plates. Then, the paste is heated and therefore sintered. Thus, the laminate is made. However, the paste undesirably flows to places where there are not supposed to be any paste. It is difficult to form a dense bonding layer because of the paste. After the sintering, the bonding layer inevitably shrinks. There are inevitably bores in the bonding layer so that there could be leak. The crystallization temperature of the bonding layer is inevitably reduced so that these elements could be detached from one another because of failure of the bonding layer.

The present invention is therefore intended to obviate or at least alleviate the problems encountered in prior art.

### SUMMARY OF INVENTION

It is an objective of the present invention to provide a system with a pressing unit and a mold for making a laminate used in a fuel cell at high temperature or the normal temperature.

It is another objective of the present invention to provide an efficient method for making a laminate for use in a fuel cell.

It is another objective of the present invention to provide a laminate with a precise size.

It is another objective of the present invention to provide a laminate with excellent air-tightness.

To achieve the foregoing objectives, the laminate includes at least two field plates and a bonding layer. Each of the flow field plates includes a plate and channels defined therein. The bonding layer is made in the form of an annular strip and sandwiched between the flow field plates, around the channels.

In an aspect of the present invention, the bonding layer includes first and second annular grooves. Each of the first and second grooves is divided into four angled sections by four blocks.

Other objectives, advantages and features of the present invention will be apparent from the following description referring to the attached drawings.

### BRIEF DESCRIPTION OF DRAWINGS

The present invention will be described via detailed illustration of the preferred embodiment referring to the drawings wherein:

FIG. 1 is an exploded view of a laminate for use in a fuel cell according to the preferred embodiment of the present invention;

FIG. 2 is a block diagram of a system for making the laminate shown in FIG. 1;

FIG. 3 is a front view of a mold used in the system shown in FIG. 2; and

FIG. 4 is a top view of the mold shown in FIG. 3.

### DETAILED DESCRIPTION OF PREFERRED EMBODIMENT

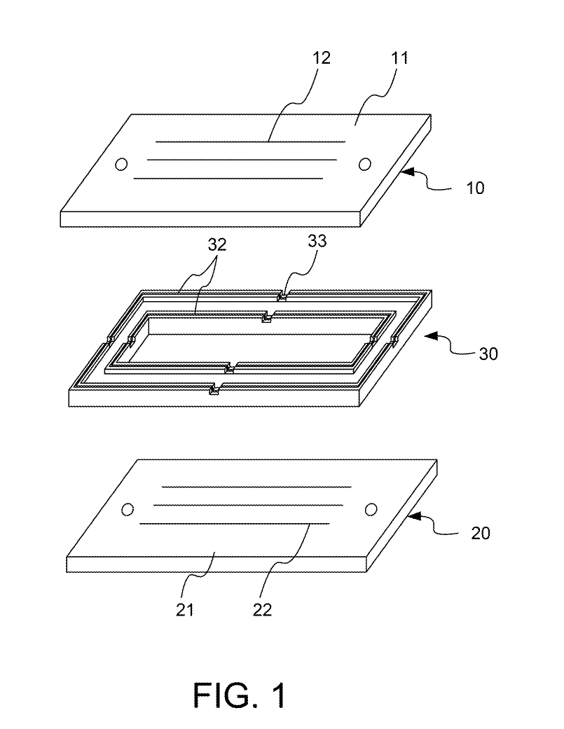

Referring to FIG. 1, there is shown a laminate for use in a fuel cell such as a solid oxide fuel cell according to the preferred embodiment of the present invention. The laminate includes at least one flow field plates 10 and 20 and a bonding layer 30 for bonding the flow field plates 10 and 20.

The flow field plate 10 includes a plate 11 and channels 12 defined in a surface of the plate 11. Similarly, the flow field plate 20 includes a plate 21 and channels 22 defined in a surface of the plate 21. The channels 22 may however be different from the channels 12.

The bonding layer 30 may be made of glass, ceramic or a mixture of glass with ceramic. The bonding layer 30 is generally made with thickness of 1 mm. The bonding layer 30 extends around the channels 12 and 22. The bonding layer 30 is preferably in the form of a square annular strip. However, the bonding layer 30 may be closed or open. The bonding layer 30 includes first and second grooves 32 defined therein. The first groove 32 extends along an internal edge of the bonding layer 30 while the second groove 32 extends along an external edge of the bonding layer 30. Hence, the second groove 32 extends around the first groove 32. Each of the first and second grooves 32 is preferably divided into four angled grooves by four blocks 33.

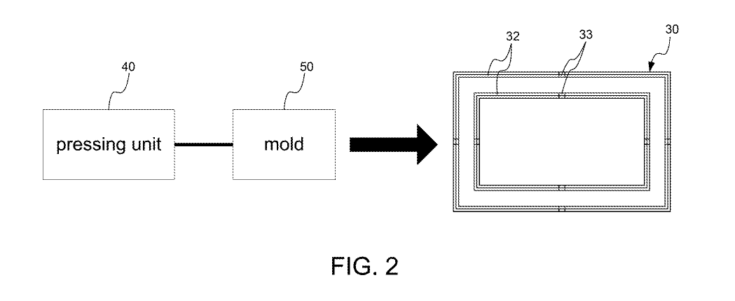

Shown in FIG. 2 is a system for making the bonding layer 30. The system includes a pressing unit 40 and a mold 50.

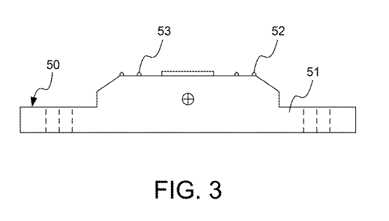

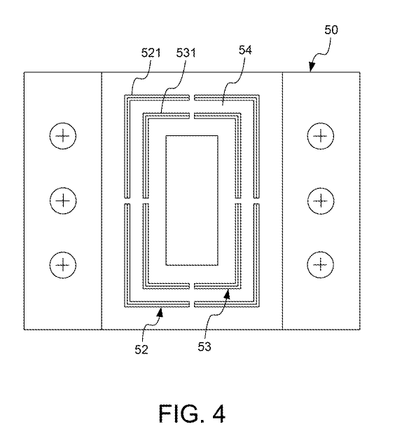

Referring to FIGS. 3 and 4, the mold 50 includes a plate 51, a first frame 52 provided on a surface of the plate 51, and a second frame 53 provided on the surface of the plate 51. The second frame 53 extends around the first frame 52. That is, the second frame 53 is larger than the first frame 52. Thus, a mold cavity 54 is defined between the first frame 52 and the second frame 53. The first frame 52 preferably includes four angled ribs 521 separated from one another by four cutouts. Similarly, the second frame 53 includes four angled ribs 521 separated from one another by four cutouts.

The mold 50 is used together with the pressing unit 40 to make a square annular strip of glass and/or ceramic at high temperature or the normal temperature. Such a square annular strip of glass and/or ceramic is used as the bonding layer 30 for use in the solar cell. The first frame 52 of the mold 50 is used to make the first groove 32 of the bonding layer 30 while the second frame 53 of the mold 50 is used to make the second groove 32 of the bonding layer 30. The blocks 33 of the first and second grooves 32 are formed because of the cutouts in the first and second frames 52 and 53.

In assembly, the bonding layer 30 is sandwiched between the flow field plates 10 and 20 around the channels 12 and 22. Heat is provided to the flow field plates 10 and 20 and the bonding layer 30 by infrared or microwave. Alternatively, pressure may be provided to the flow field plates 10 and 20 and the bonding layer 30. Thus, the flow filed plates 10 and 20 and the bonding layer 30 are joined together.

As discussed above, the bonding layer 30 is made by the system including the pressing unit 40 and the mold 50 at high temperature or the normal temperature. The bonding layer 30 is used to bond the flow field plates 10 and 20. Therefore, the heating and pressing can synchronously be executed to bond the flow filed plates 10 and 20 by the bonding layer 30. The bonding layer 30 is a strip. Therefore, the bonding layer 30 is more rigid than the conventional bonding layer made of powder discussed in the Related Prior Art. The bonding layer 30 cannot be excessively deformed that often occurs in the conventional bonding layer. Thus, the size of the bonding layer 30 is precise. Moreover, there are less bores in the bonding layer 30 than in the conventional bonding layer. Thus, the air-tightness of the bonding layer 30 is excellent.

The present invention has been described via the detailed illustration of the preferred embodiment. Those skilled in the art can derive variations from the preferred embodiment without departing from the scope of the present invention. Therefore, the preferred embodiment shall not limit the scope of the present invention defined in the claims.

1. A laminate for use in a fuel cell, the laminate comprising:
at least two flow field plates 10, 20 each including a plate 11, 21 and channels 12, 22 defined therein; and
a bonding layer 30 made in the form of an annular strip and sandwiched between the flow field plates 10, 20, around the channels 12, 22.

2. The laminate according to claim 1, wherein the laminate is used in a solid oxide fuel cell.

3. The laminate according to claim 1, wherein the flow field plates 10, 20 are bonded through the bonding layer 30 by heating and pressing.

4. The laminate according to claim 3, wherein the heating is provided by a method selected from the group consisting of infrared or microwave.

5. The laminate according to claim 1, wherein the bonding layer 30 is made of at least one material selected from the group consisting of glass and ceramic.

6. The laminate according to claim 1, wherein the bonding layer 30 includes first and second annular grooves 32.

7. A mold for making the bonding layer 30 according to claim 6, the mold comprising a plate 51 and first and second annular ribs 52, 53 extending on the plate 51, wherein the first and second annular ribs 52, 53 are used to make the first and second annular grooves 32 in the bonding layer 30.

8. The laminate according to claim 6, wherein each of the first and second grooves 32 is divided into four angled sections by four blocks 33.

9. A mold for making the bonding layer 30 according to claim 8, the mold including a plate 51 and first and second annular ribs 52, 53 extending on the plate 51, wherein the first and second annular ribs 52, 53 are used to make the first and second annular grooves 32 in the bonding layer 30, wherein each of the first and second annular ribs 52, 53 are divided into four angled sections 521, 531 for making the angled sections of a related one of the first and second annular grooves 32 in the bonding layer 30.

10. The laminate according to claim 1, wherein the bonding layer 30 extends along a closed path.

11. The laminate according to claim 1, wherein the bonding layer 30 includes separated sections.
